(19) United States
(12) Patent Application Publication
(10) Pub. No.: US 2013/0141957 A1
(43) Pub. Date: Jun. 6, 2013

(54) POWER CONVERSION DEVICE

(71) Applicant: Tetsuo Tanaka, Chiyoda-ku (JP)

(72) Inventor: Tetsuo Tanaka, Chiyoda-ku (JP)

(73) Assignee: MITSUBISHI ELECTRIC CORPORATION, Chiyoda-ku, Tokyo (JP)

(21) Appl. No.: 13/816,300

(22) PCT Filed: Aug. 10, 2010
(86) PCT No.: PCT/JP2010/063526

§ 371 Date: Feb. 11, 2013

(51) Int. Cl. H02M 7/21

(52) U.S. Cl. CPC H02M 7/21
USPC 363/97

(57) ABSTRACT

An electrode pattern is arranged near an output pattern, a leakage current leaked from the output pattern is detected by a leakage-current detection circuit via the electrode pattern, and a light emitting diode is driven based on a detection result of the leakage-current detection circuit, thereby notifying an operation state of an inverter.

### FIELD

The present invention relates to a power conversion device, and more particularly to a system in which an output state of a power conversion device can be visualized.

### BACKGROUND

As a method of detecting an output state of a power conversion device, there are methods such as that of detecting a voltage by directly connecting a signal input unit to an electric path of a power conversion device and that of detecting a current by a current transformer in which a circumference of an electric path is sandwiched by cores.

Furthermore, Patent Literature 1 discloses a technique in which a detection unit is sandwiched by power cords or signal lines that are connected to an electronic device, common mode noise generated by an operation of the electronic device is detected, and then an operation status of the electronic device is detected from outside in a non-contact manner.

Further, Patent Literature 2 discloses a technique in which a sensor unit is arranged to be close to outside of a power-supply cable of an electric device, a magnetic flux generated by a current flowing into the power-supply cable at the time of operating the electric device is detected by the sensor unit, and then existence of power distribution is detected at an arbitrary position in the power-supply cable.

### CITATION LIST

### Patent Literatures

Patent Literature 1: Japanese Patent Application Laid-open No. 2007-120956
Patent Literature 2: Japanese Patent Application Laid-open No. 2002-368191

### SUMMARY

### Technical Problem

However, in the method of directly connecting a signal input unit to an electric path of a power conversion device, an output voltage of the power conversion device is a high voltage. Therefore, a resistor for voltage reduction and a photocoupler for insulation are required, and the requirement of these elements causes problems such as an increase of parts costs and an increase of an installation space.

In the method of using a current transformer, it is necessary to sandwich a circumference of an electric path by cores, and thus there are problems such as restrictions in the installing position of the current transformer and installation thereof is not easy.

In the method disclosed in Patent Literature 1, it is necessary to have a detection unit sandwiched by power cords or signal lines, and there is a problem that a large space is required around the power cords or signal lines.

In the method disclosed in Patent Literature 2, there are problems that a magnetic sensor is expensive and an increased installation space therefor is required.

The present invention has been achieved in view of the above problems, and an object of the present invention is to provide a power conversion device that can detect an output state of the power conversion device in a non-contact manner while suppressing an increase of an installation space.

### Solution to Problem

### Advantageous Effects of Invention

According to the present invention, it is possible to detect an output state of the power conversion device while suppressing an increase of an installation space.

### BRIEF DESCRIPTION OF DRAWINGS

FIG. 1 is a block diagram of a schematic configuration of a power conversion device according to a first embodiment of the present invention.

FIG. 2 is a circuit diagram of a configuration example of a leakage-current detection circuit 11 and a driver 13 in FIG. 1.

FIG. 3 depicts an input/output waveform of a comparator PA in FIG. 2 at an output time of a power conversion device 5 in FIG. 1.

FIG. 4 depicts an input/output waveform of the comparator PA in FIG. 2 at an output stopping time of the power conversion device 5 in FIG. 1.

FIG. 5(a) is a plan view of a schematic configuration of the power conversion device 5 in FIG. 1, and FIG. 5(b) is a side view of a schematic configuration of the power conversion device 5 in FIG. 1.

FIG. 6 is a cross-sectional view of a schematic configuration of a main circuit board 25 cut along a line A-A′ in FIG. 5(a).

### DESCRIPTION OF EMBODIMENTS

Exemplary embodiments of a power conversion device according to the present invention will be explained below in detail with reference to the accompanying drawings. The present invention is not limited to the embodiments.

### First Embodiment

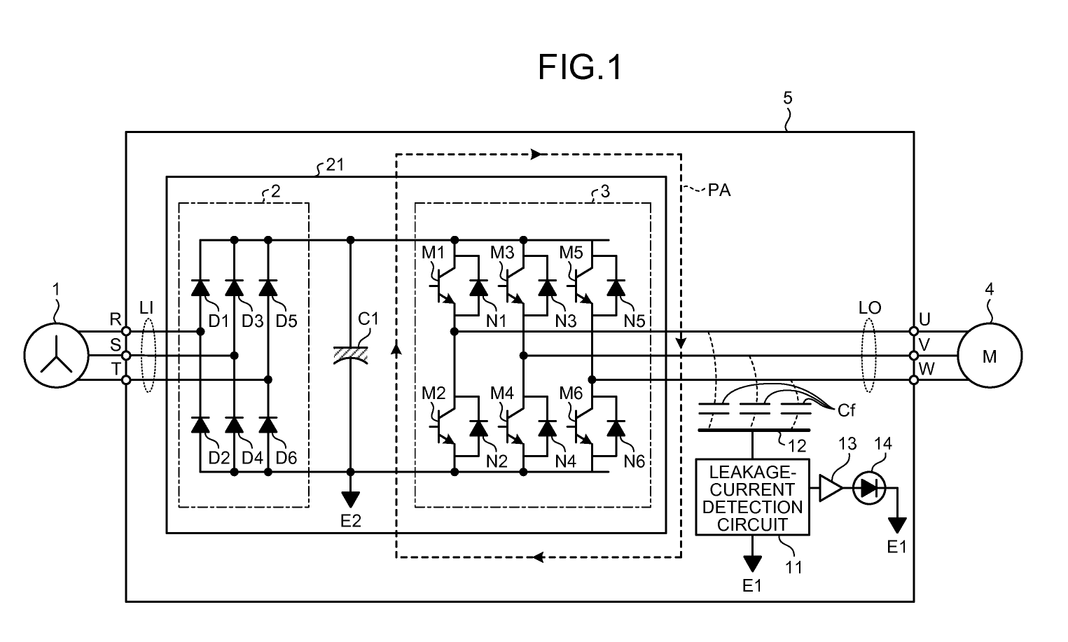

FIG. 1 is a block diagram of a schematic configuration of a power conversion device according to a first embodiment of the present invention. As shown in FIG. 1, a power conversion device 5 includes a converter 2 that converts an alternate current with a commercial frequency into a direct current and an inverter 3 that converts a direct current into an alternate current with a desired frequency. In this example, an R-phase input terminal R, an S-phase input terminal S, and a T-phase input terminal T are provided on a side of the converter 2, and a U-phase output terminal U, a V-phase output terminal V, and a W-phase output terminal W are provided on a side of the inverter 3.

The converter 2 is connected to a three-phase power supply 1 via the R-phase input terminal R, the S-phase input terminal S, and the T-phase input terminal T, and the inverter 3 is connected to a motor 4 via the U-phase output terminal U, the V-phase output terminal V, and the W-phase output terminal W. In this example, the R-phase input terminal R, the S-phase input terminal S, and the T-phase input terminal T are connected to the converter 2 via an input pattern LI. The U-phase output terminal U, the V-phase output terminal V, and the W-phase output terminal W are connected to the inverter 3 via an output pattern LO.

Rectifier diodes D1 to D6 are provided in the converter 2. The rectifier diodes D1 and D2 are connected to each other in series, the rectifier diodes D3 and D4 are connected to each other in series, and the rectifier diodes D5 and D6 are connected to each other in series. The R-phase input terminal R is provided at a connection point between the rectifier diodes D1 and D2, the S-phase input terminal S is provided at a connection point between the rectifier diodes D3 and D4, and the T-phase input terminal T is provided at a connection point between the rectifier diodes D5 and D6.

A smoothing capacitor C1 is connected in parallel to a series circuit of the rectifier diodes D1 and D2, a series circuit of the rectifier diodes D3 and D4, and a series circuit of the rectifier diodes D5 and D6.

Switching elements M1 to M6 and free-wheeling diodes N1 to N6 are provided in the inverter 3. As the switching elements M1 to M6, an IGBT, a bipolar transistor, and a field-effect transistor can be used.

In this example, the free-wheeling diodes N1 to N6 are respectively connected in parallel to the switching elements M1 to M6. The switching elements M1 and M2 are connected to each other in series, the switching elements M3 and M4 are connected to each other in series, and the switching elements M5 and M6 are connected to each other in series. The U-phase output terminal U is provided at a connection point between the switching elements M1 and M2, the V-phase output terminal V is provided at a connection point between the switching elements M3 and M4, and the W-phase output terminal W is provided at a connection point between the switching elements M5 and M6.

The power conversion device 5 also includes an electrode pattern 12 that is arranged near the output pattern LO, a leakage-current detection circuit 11 that detects a leakage current PA leaked from the output pattern LO via the electrode pattern 12, a driver 13 that drives a light emitting diode 14 based on a detection result of the leakage-current detection circuit 11, and the light emitting diode 14 that notifies an operation state of the inverter 3. The electrode pattern 12 can form floating capacitances Cf between the electrode pattern 12 itself and the output pattern LO.

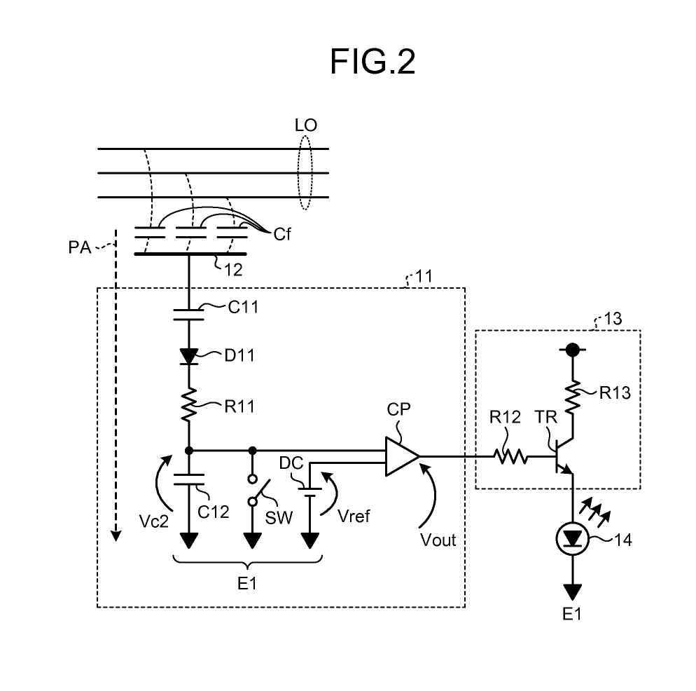

FIG. 2 is a circuit diagram of a configuration example of the leakage-current detection circuit 11 and the driver 13 in FIG. 1. In FIG. 2, the leakage-current detection circuit 11 includes capacitors C11 and C12, a diode D11, a resistor R11, a switch SW, a reference power supply DC, and a comparator CP. The driver 13 includes resistors R12 and R13 and a transistor TR.

Furthermore, the electrode pattern 12 is connected to one of input terminals of the comparator CP via the capacitor C11, the diode D11, and the resistor R11 in this order. The one of the input terminals of the comparator CP is connected to the capacitor C12. The capacitor C12 is connected to the switch SW in parallel. The reference power supply DC is connected to the other one of the input terminals of the comparator CP.

An output terminal of the comparator CP is connected to a base of the transistor TR via the resistor R12. A collector of the transistor TR is connected to a power-supply potential via the resistor R13, and an emitter of the transistor TR is connected to the light emitting diode 14.

An operation of the power conversion device 5 in FIG. 1 is explained below.

When an alternate current is input from the three-phase power supply 1 to the converter 2, the alternate current is converted into a direct current by the converter 2, and the direct current is input to the inverter 3. Subsequently, in the inverter 3, the direct current is converted into an alternate current according to switching operations of the switching elements M1 to M6, and the alternate current is supplied to the motor 4, thereby driving the motor 4 by PWM control.

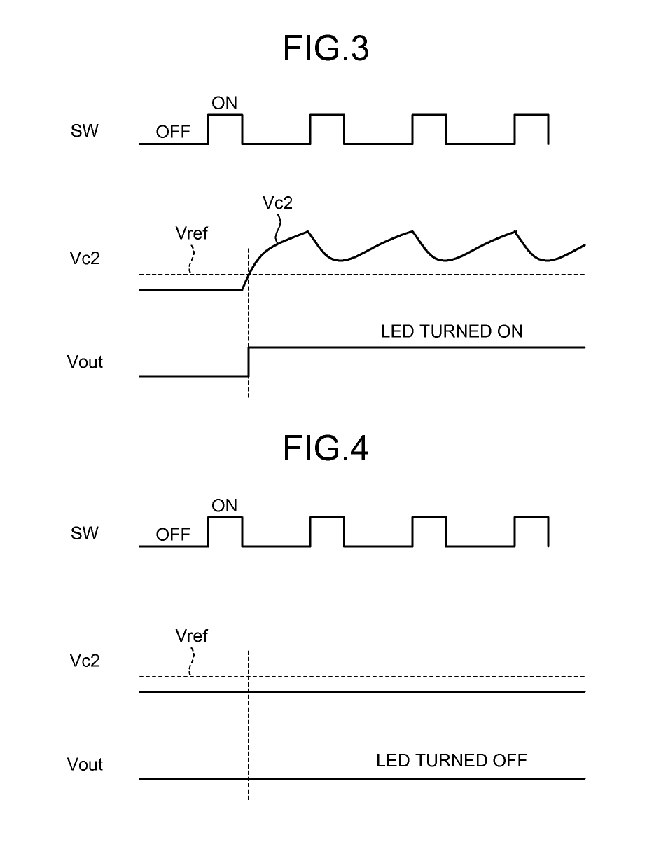

FIG. 3 depicts an input/output waveform of the comparator PA in FIG. 2 at an output time of the power conversion device 5 in FIG. 1. In FIG. 3, when the switching elements M1 to M6 in FIG. 1 perform switching operations, the leakage current PA flows through the floating capacitances Cf in each of the switching operations due to high-speed on/off switching.

The leakage current PA at this time can be expressed by an expression of PA=Cf·dv/dt. The “dv/dt” represents a switching speed of the switching elements M1 to M6. The leakage current PA flows in a route from the smoothing capacitor C1, the switching elements M1 to M6, the output pattern LO, the electrode pattern 12, the leakage-current detection circuit 11, a ground point E1, a ground point E2, and the smoothing capacitor C1 in this order. At this time, the capacitor C12 of the leakage-current detection circuit 11 is charged by the leakage current PA.

Subsequently, as the capacitor C12 is charged, when an inter-terminal voltage Vc2 of the capacitor C12 becomes equal to or larger than a reference voltage Vref that is given by the reference power supply DC, an output voltage Vout of the comparator CP is turned on. As a result, the transistor TR is switched on, a current flows to the light emitting diode 14 via the transistor TR, and the light emitting diode 14 is illuminated, thereby notifying that the inverter 3 is operating.

At this time, the switch SW is turned on and off at a constant period, and the capacitor C12 is discharged intermittently. The on/off period of the switch SW at this time can be set such that, at an output time of the power conversion device 5, the inter-terminal voltage Vc2 of the capacitor C11 does not become lower than the reference voltage Vref.

FIG. 4 depicts an input/output waveform of the comparator PA in FIG. 2 at an output stopping time of the power conversion device 5 in FIG. 1. In FIG. 4, the leakage current PA is expressed as PA=Cf·dv/dt, and when switching operations of the switching elements M1 to M6 are stopped, the “dv/dt” becomes 0. Therefore, the leakage current PA does not flow out from the output pattern LO, and the electrode pattern 12 is not charged through the floating capacitances Cf.

At this time, because the switch SW is turned on and off at a constant period, electric charge accumulated in the capacitor C12 is discharged and the inter-terminal voltage Vc2 of the capacitor C12 becomes lower than the reference voltage Vref, and thus the output voltage Vout of the comparator CP becomes a low level.

As a result, the transistor TR is switched off, a current that flows to the light emitting diode 14 is blocked by the transistor TR, and the illumination of the light emitting diode 14 is turned off, thereby notifying that the inverter 3 is not operating.

In this case, by detecting the operation state of the inverter 3 based on the leakage current PA detected via the electrode pattern 12, it becomes unnecessary to directly connect a signal input unit to an electric path of the power conversion device 5 and to sandwich a detection unit by power cords or signal lines. Therefore, it becomes possible to detect an output state of the power conversion device 5 in a non-contact manner while suppressing an increase of an installation space.

In the above embodiment, a case of using the light emitting diode 14 as a notification unit that notifies the operation state of the inverter 3 has been explained; however, a light bulb, a liquid crystal display device, and the like can be also used as the notification unit.

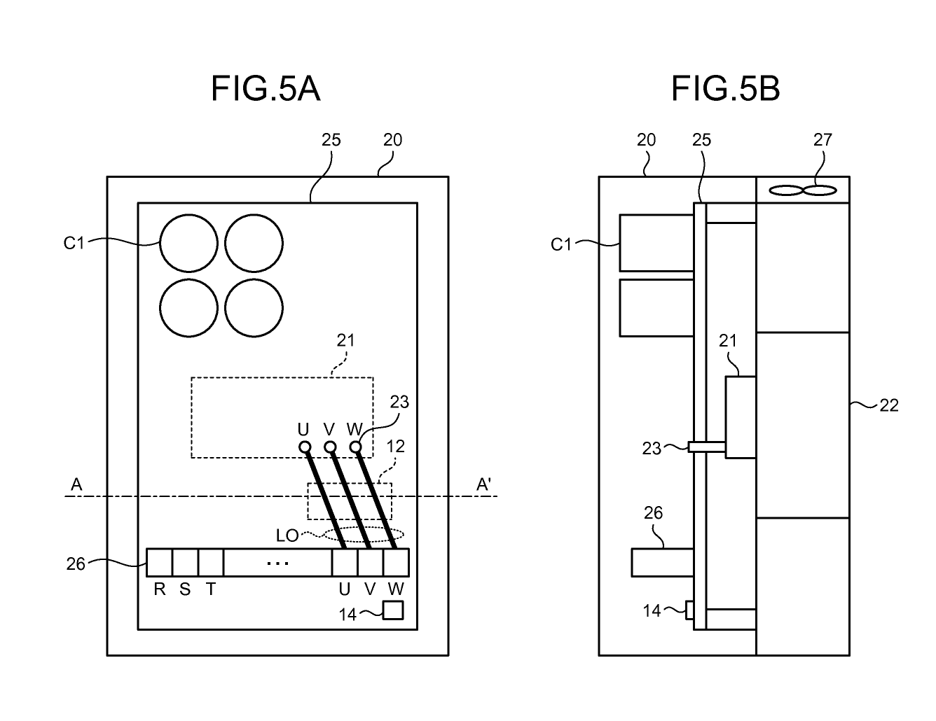

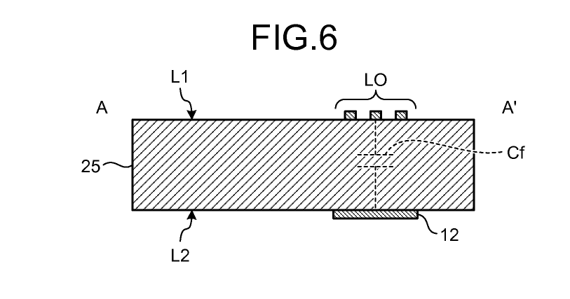

FIG. 5(a) is a plan view of a schematic configuration of the power conversion device in FIG. 1, and FIG. 5(b) is a side view of a schematic configuration of the power conversion device in FIG. 1. In FIG. 5, a semiconductor module 21 is mounted on a main circuit board 25 and is electrically connected to the main circuit board 25 via a module pin 23. A semiconductor chip having the switching elements M1 to M6, the rectifier diodes D1 to D6, and the free-wheeling diodes N1 to N6 in FIG. 1 formed thereon is incorporated in the semiconductor module 21.

Furthermore, a heat sink 22 that discharges heat generated by the semiconductor module 21 is arranged on a rear surface of the semiconductor module 21. A fan 27 that blows air to the heat sink 22 is provided near the heat sink 22. The module pin 23 is extracted from a front-surface side of the semiconductor module 21.

The smoothing capacitor C1 and a main-circuit terminal block 26 are mounted on the main circuit board 25. The output pattern LO is formed on the main circuit board 25, and the module pin 23 and the main-circuit terminal block 26 are connected to each other via the output pattern LO for each one of a U-phase, a V-phase, and a W-phase.

The R-phase input terminal R, the S-phase input terminal S, the T-phase input terminal T, the U-phase output terminal U, the V-phase output terminal V, and the W-phase output terminal W can be provided in the main-circuit terminal block 26.

The main circuit board 25 has the electrode pattern 12 formed thereon near the output pattern LO. The light emitting diode 14 is mounted on the main circuit board 25, and the light emitting diode 14 can be arranged near the U-phase output terminal U, the V-phase output terminal V, or the W-phase output terminal W in the main-circuit terminal block 26.

In this example, by mounting the light emitting diode 14 on the main circuit board 25, the operation state of the inverter 3 can be easily checked when a cable is wired in the main-circuit terminal block 26. Therefore, safety at the time of checking the operation state of the inverter 3 can be improved.

FIG. 6 is a cross-sectional view of a schematic configuration of a main circuit board cut along a line A-A′ in FIG. 5(a). In FIG. 6, a wiring layer L1 is arranged on a front surface of the main circuit board 25, and a wiring layer L2 is arranged on a rear side of the main circuit board 25. Furthermore, output patterns LO are formed on the wiring layer L1, and the electrode pattern 12 is formed on the wiring layer L2. It is preferable that the electrode pattern 12 is arranged to face at least one layer of any one of the output patterns LO.

At least any one of the electrode pattern 12 and the output patterns LO can be arranged on an inner layer of the main circuit board 25. In this case, it is preferable that the electrode pattern 12 and the output patterns LO are arranged to face mutually adjacent layers of the main circuit board 25.

In this example, by forming any one of the electrode pattern 12 and the output patterns LO on an inner layer of the main circuit board 25, it becomes possible to suppress an increase of the area of the main circuit board 25, thereby suppressing enlargement of the power conversion device 5.

### INDUSTRIAL APPLICABILITY

As described above, the power conversion device according to the present invention can detect an output state of a power conversion device in a non-contact manner while suppressing an increase of an installation space, and is suitable for a method of visualizing an output state of a power conversion device.

### REFERENCE SIGNS LIST

1 three-phase power supply
2 converter
3 inverter
4 motor
5 power conversion device
D1 to D6 rectifier diode
C1 smoothing capacitor
M1 to M6 switching element
N1 to N6 free-wheeling diode
11 leakage-current detection circuit
12 electrode pattern
13 driver
14 light emitting diode
LI input pattern
LO output pattern
R R-phase input terminal
S S-phase input terminal
T T-phase input terminal
U U-phase output terminal
V V-phase output terminal
W W-phase output terminal
21 semiconductor module
22 heat sink
23 module pin
25 main circuit board
26 main-circuit terminal block
27 fan
L1, L2 wiring layer
C11, C12 capacitor
D11 diode
R11 to R13 resistor
SW switch
DC reference power supply
CP comparator
TR transistor

1.-6. (canceled)

7. A power conversion device comprising:
an electrode pattern that forms a floating capacitance between the electrode pattern and an output pattern that is connected to an inverter;
a leakage-current detection circuit that accumulates a leakage current leaked from the output pattern as electric charge in a capacitor via the electrode pattern, and detects whether a value corresponding to the electric charge is equal to or larger than a reference value; and
a notification unit that notifies an operation state of the inverter based on a detection result of the leakage-current detection circuit, and
wherein the leakage-current detection circuit includes
the capacitor that coverts accumulated electric charge into a voltage,
a switch that is turned off so that electric charge transmitted from the electrode pattern is charged in the capacitor, and is turned on so that the electric charge is discharged from the capacitor, and
a detection unit that detects a fact that a voltage of the capacitor has become equal to or larger than a reference voltage, and
when a fact that the voltage of the capacitor has become equal to or larger than the reference voltage is detected by the detection unit, the notification unit notifies that the inverter is operating.

8. The power conversion device according to claim 7, wherein
the switch is turned on and off alternately at a constant period.
